(19) United States
(12) Patent Application Publication
(10) Pub. No.: US 2017/0262142 A1
(43) Pub. Date: Sep. 14, 2017

(54) Interface for Accessing Target Data and Displaying Output to a User

(71) Applicant: Cronus Consulting Group Pty Ltd, Sydney, NSW (AU)

(72) Inventor: Steven Riley, Sydney, NSW (AU)

(73) Assignee: Cronus Consulting Group Pty Ltd, Sydney, NSW (AU)

(21) Appl. No.: 15/321,777

(22) PCT Filed: Jul. 31, 2015
(86) PCT No.: PCT/AU2015/050433

§ 371 Date: Dec. 23, 2016

(30) Foreign Application Priority Data
Jul. 31, 2014 (AU) 2014902970

(51) Int. Cl. G06F 3/0482; G06F 3/0484

(52) U.S. Cl. CPC G06F 3/0482; G06F 3/04847; G06F 3/04845; G06Q 40/00

(57) ABSTRACT

A user interface system and method for accessing big or other data stored in a data store. The interface system includes an interface generator for generating a user interface layout. The interface layout inputs control data from a user to a database management system that may access a data store of big or other data to conveniently extract filtered data from the data store. The user interface layout has: (i) a main header bar divided into a plurality of expandable portions each in the form of a slide-out menu or activatable ribbon will for the user to input the control data; and (ii) a main display pane for displaying the filtered data output from the database management system. The main display pane is always maximised to provide the maximum area available for displaying the filtered data.

### FIELD OF THE INVENTION

This invention relates to a user interface system and method for accessing target data and for displaying output to a user derived from target data in a convenient and user-friendly manner.

The invention has particular, but not exclusive, utility for generating output from input control data that is able to configure or filter the target data and display the output in a format suitable for the purposes of a user in an efficient manner. This is particularly useful when dealing with big or other global financial and/or non-financial data related to the management of an organisation, or for performing analytics or diagnostics on such data or a discrete set of data extracted from the big or other data.

Throughout the specification, unless the context requires otherwise:

the word “comprise” or variations such as “comprises” or “comprising”, will be understood to imply the inclusion of a stated integer or group of integers but not the exclusion of any other integer or group of integers;

the term “big data” will be understood to mean a data set that is too large or complex to manipulate or interrogate with standard methods and tools;

the term “other data” will be understood to mean a data set that is not big data, but is still large enough for the invention to have practical application with;

the term “target data” will be understood to mean a data set that comprises big data or other data or a discrete set of data derived or extracted from such; and the term “business unit” will be understood to mean an organisation or organisational subset that is independent with regard to one or more accounting or operational functions being derived from either the financial or non-financial systems of an organisation.

### BACKGROUND ART

The following discussion of the background art is intended to facilitate an understanding of the present invention only. It should be appreciated that the discussion is not an acknowledgement or admission that any of the material referred to was part of the common general knowledge as at the priority date of the application.

The design of interfaces for accessing complex databases containing big or other data, rich with detailed information such as financial and/or non-financial data related to an organisation, has generally been driven in a manner to complement the system associated with compiling the data. In the case of Enterprise Resource Planning (ERP) systems, this generally takes the form of a menu driven hierarchical structure emulating the structure of the ERP system.

ERP systems such as those developed by SAP™ and Oracle™ typically contain complex databases involving mass data storage of big or other data, but can be very restrictive to users in many ways. For example:
Users require some degree of technical skill to operate the ERP System;
Licensing, support and training costs can restrict users access to such systems making them prohibitive or not cost effective to use;
ERP systems are often designed for use by accountants and not business managers.

Improvements in these ERP systems have been incremental whilst much of the methodology remains the same for:
extracting data;
producing reports; and
user interfaces.

Consequently, the user interfaces tend to be antiquated and are not suited to modern and rapid data processing systems that are able to access and extract target data from big or other data. This makes for slow and staged control data input for configuration of the big or other data, selection of options and filters and protracted display of output in a format suitable for the user.

### DISCLOSURE OF THE INVENTION

It is an object of the present invention to provide for a simplified user interface to access target data and which permits the generation of customisable output derived or extracted from the target data, for the purposes of the user.

In accordance with one aspect of the present invention, there is provided a user interface system for accessing target data including:

an interface generator for generating a user interface for the purposes of inputting control data from a user to access the target data and for outputting data from the target data in response to the inputting of the control data;

wherein:

the user interface has: (i) a bar divided into a plurality of expandable portions, at least one expandable portion in its expandable form providing an extendable area for the user to input control data; and (ii) a main display pane for displaying the data output from the target data;

the main display pane is always maximised to provide the maximum area available for displaying the data; and

the one expandable portion of the main header bar can be selectively targeted by user input to:

(a) minimise or retract the extended area so that it does not encroach upon the main display pane; or alternatively

(b) reveal the extended area in a manner so as to not, or minimally, encroach into the main display pane, mitigating the obscuration of the main display pane.

Preferably, the extended area is a ribbon that can selectively be:

(i) retracted in a deactivated state so as not to encroach upon the main display pane; or

(ii) extended to encroach minimally into the main display pane so as to mitigate the obscuration of the main display pane.

Preferably, the ribbon is activatable when extended and can selectively be:

(i) de-activated to encroach minimally into the main display pane so as to mitigate the obscuration of the main display pane; or

(ii) activated to encroach marginally further into the main display pane but still mitigating the obscuration of the main display pane.

Preferably, the ribbon has (A) a portion for inputting configuration information as a part of the control data to allow the user to filter the target data and extract from it output data to form filtered data for outputting to the user according to a prescribed range of filter settings available to the user.

Preferably, the activatable ribbon has (B) another portion for inputting formatting data as part of the control data to allow the user to choose one of a plurality of format settings for displaying the filtered data according to a format setting of their choosing.

Preferably, the activatable ribbon further has (C) a further portion for providing hyperlinks to a related set of prescribed output that may be generated from the same configuration information entered at (A).

Preferably, the activatable ribbon further still has (D) a still further portion for providing a favourites list of previously stored configuration information from (A) and formatting data from (B) to facilitate the user populating the respective fields in (A) or (B) by selecting from the favourites list and entering (C) to provide a prescribed output using the previously stored configuration information and formatting data.

Preferably, the one expandable portion is disposed intermediate of the bar, and when expanded, the extended area associated therewith with is displayed adjacent and in parallel to the bar so as to encroach minimally upon the main display pane.

Preferably, the one expandable portion is disposed at one end of bar and when expanded, the extended area associated therewith is displayed laterally of the bar so as not to encroach upon the main display pane, and the main display pane is shifted in conjunction with the remaining portion of the bar in the opposite direction.

Preferably, the extended area is a slide-out menu and includes a series of menu selections and sub menu selections providing for different types of control settings for the user to choose or select from for accessing the target data.

Preferably, the slide-out menu provides control settings for: (i) the user to choose or select different types of output for controlling the extraction and display of the output data; or (ii) governing the status and access of the user to the target data; or (iii) both (i) and (ii).

Preferably, in the case of (iii), the slide-out menu for (i) is located at one of the ends of the bar, and the slide-out menu for (ii) is located at the opposite end of the bar.

In accordance with another aspect of the present invention, there is provided a method for a user accessing target data including:

generating a user interface layout so that it has: (i) a bar divided into a plurality of expandable portions, at least one expandable portion in its expandable form providing an extended area for the user to input control data; and (ii) a main display pane for displaying the data output from the target data, the main display pane always being maximised to provide the maximum area available for displaying the data output from the target data;

wherein the one expandable portion of the bar can be selectively targeted by a user input to: (a) minimise or retract the extended area so that it does not encroach upon the main display pane; or alternatively (b) reveal the extended area in a manner so as to not, or minimally, encroach into the main display pane, mitigating the obscuration of the main display pane.

Preferably, the extended area is a ribbon and the method includes: (i) retracting the ribbon in a deactivated state so as not to encroach upon the main display pane; or (ii) extending the ribbon to encroach minimally into the main display pane so as to mitigate the obscuration of the main display pane.

Preferably the method includes selectively: (i) deactivating the ribbon to encroach minimally into the main display pane so as to mitigate the obscuration of the main display pane; or (ii) activating the ribbon to encroach marginally further into the main display pane but still mitigating the obscuration of the main display pane.

Preferably, the method includes dividing the ribbon into: (A) a portion for inputting configuration information as a part of the control data to allow the user to filter the target data in the data store and extract only that data which is required to form filtered data for outputting to the user according to a prescribed range of filter settings available to the user.

Preferably, the method includes dividing the ribbon into: (B) another portion for inputting formatting data as part of the control data to allow the user to customise the formatting of the filtered data for their own purposes.

Preferably, the method includes dividing the ribbon into: (C) a further portion for providing hyperlinks to a related set of prescribed analytics, diagnostics or reports that may be generated from the same configuration information entered at (A).

Preferably, the method includes dividing the ribbon into: (D) a still further portion for providing a favourites list of previously stored configuration information from (A) and formatting data from (B) to facilitate the user populating the respective fields in (A) or (B) by selecting from the favourites list and entering (C) to run a prescribed analytics, diagnostics or report using the previously stored configuration information and formatting data.

Preferably, the method includes disposing one of the expandable portions at the end of the bar and expanding the extended area associated therewith to display laterally of the bar so as not to encroach upon the main display pane, and shifting the main display pane in conjunction with the remaining portion of the bar in the opposite direction.

Preferably, the extended area is a slide-out menu and includes a series of menu selections and sub menu selections providing for different types of control settings for the user to choose or select from for accessing the target data.

Preferably, the slide-out menu provides control settings for: (i) the user to choose or select different types of output for controlling the extraction and display of the target data; or (ii) governing the status and access of the user to the target data; or (iii) both (i) and (ii).

Preferably, in the case of (iii), the method includes locating the slide-out menu for (i) at one of the ends of the bar, and locating the slide-out menu for (ii) at the opposite end of the bar.

### BRIEF DESCRIPTION OF THE DRAWINGS

The invention will be better understood in the light of the ensuing description of the best mode for carrying out the invention. The description is made with reference to the following drawings of a specific embodiment of the best mode, wherein:

FIG. 1 is a schematic diagram of the client/server embodiment of the user interface system in an Internet environment;

FIG. 2 is a schematic block diagram of the general structure of the server of FIG. 1;

FIG. 3a is a representation of the user interface layout with the main header bar in one expanded state with the ribbon activated but minimised;

FIG. 3b is a similar view to FIG. 3a showing the main header bar in another expanded state with the ribbon activated and partially maximised;

FIG. 3c is a similar view to FIG. 3a but showing the main header bar in the unexpanded state with the ribbon deactivated;

FIG. 3d is a representation of the user interface layout with the left-hand side expandable portion of the main header bar in another expanded state;

FIG. 3e is a representation of the user interface layout with the right hand side expandable portion of the main header bar in still another expanded state;

FIG. 4 is flow diagram showing the general processes followed when using the user interface system; and

FIG. 5 is a flow chart showing the logical steps followed by a user and performed by the user interface system from when a user first invokes the user interface system and accesses the big or other data stored in the data store.

### BEST MODE(S) FOR CARRYING OUT THE INVENTION

The best mode for carrying out the invention is described with respect to several specific embodiments directed towards a user interface system and method for a user accessing target data in a data store.

In the present embodiment, the target data is derived from the financial and non-financial systems of an organisation, which characterise the organisation and its business units in terms of its operational requirements or practices. These include output in the form of internal reporting requirements and analysis and/or diagnostics of non-financial data and/or regulatory specification as determined by statutory and non-statutory reporting requirements, and/or by particular customised ERP systems such as SAP™ or ORACLE™ designed specifically for a particular service or manufacturing sector.

The manner in which target data may be generated and output data derived is described in the applicant's co-pending International Patent Application PCT/AU2015/050366, which is incorporated herein by reference, but will not be described in detail as it is not central to the subject invention.

In this arrangement, basically raw data characterising an organisation and its business units in terms of its operational requirements or practices, undergoes a two-stage mapping process performed by a data processing system, where the second stage of mapping transforms the data to big or other data according to prescribed mapping rules, which is stored in a data store. The mapping rules are detailed according to prescribed groups that characterise the organisation in terms of its management specification.

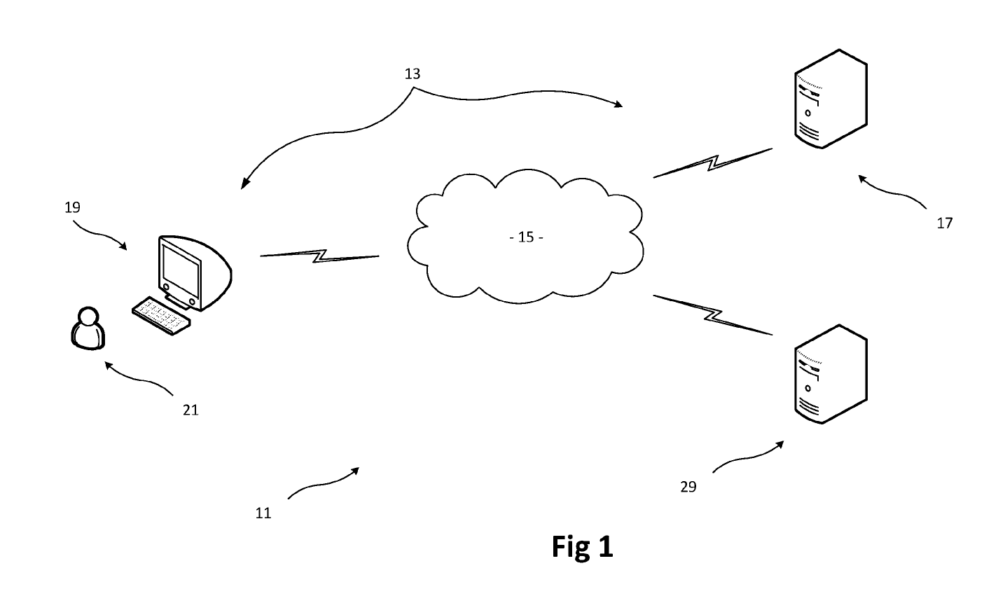

According to the present embodiment, as shown in FIG. 1, the user interface system 11 is embodied in a client/server arrangement 13 disposed in an Internet environment 15, which can take advantage of cloud computing resources.

In this arrangement, a server 17 can be hosted remotely of a client 19 and include high power computing services with appropriate speed and processing power to service a large number of clients located in different geographical locations. The client 19 can be any suitable computing device by which a user 21 can access the server 17 using a browser.

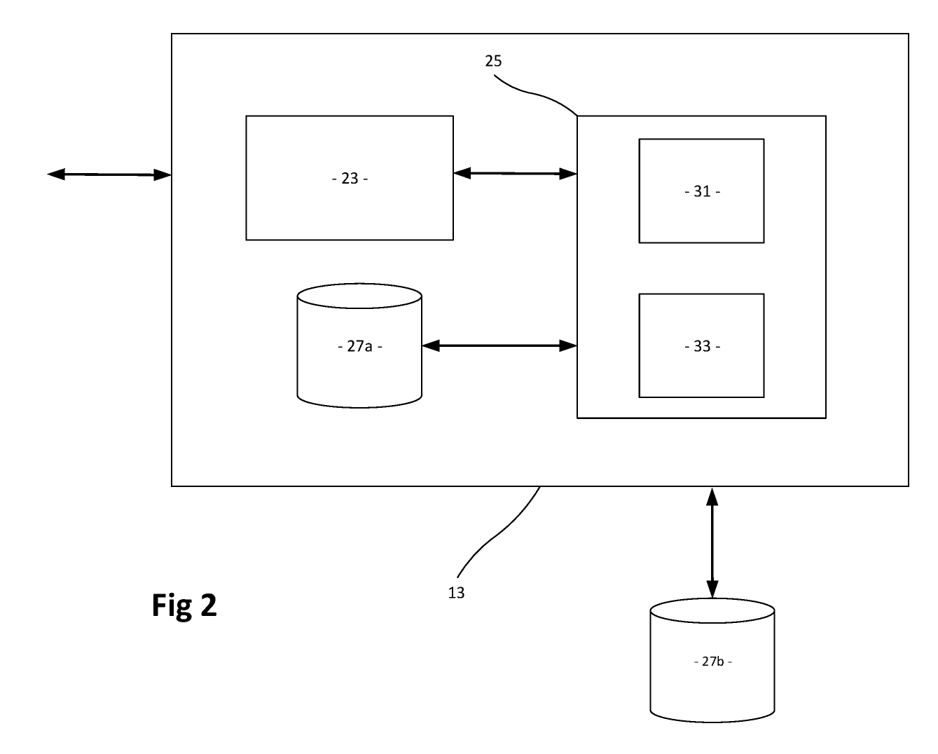

The server 17, as shown in FIG. 2, includes a communication module 23, an analytics and reporting engine 25 and a data store 27 including a local store 27a serving as a cache, and a remote store 27b. The remote store 27b can itself be hosted remotely by another server 29 and be part of a larger database processing system where the target data is generated and stored within a server bank. In this manner large volumes of target data may be cost effectively stored and retrieved. By way of this arrangement, big or other data can be retrieved from the remote store 27b for local storage within the cache of the local store 27a, where it can be rapidly accessed, depending upon the needs of the users 21, as determined and controlled by the analytics and reporting engine 25.

The communication module 23 is in communication with the analytics and reporting engine 25 and provides for communications between the server 17 and various users 21 of the user interface system 11 by the Internet 15, including communications between the analytics and reporting engine 25 and the remote store 27b.

The analytics and reporting engine 25 includes a cloud based interface generator 31 and a database management system 33. The interface generator 31 generates a user interface in the form of a layout 35 for a user to use for: (i) inputting control data to the database management system 33 for accessing the target data stored on the data store 27; and (ii) for outputting data in the form of filtered data received from the database management system in response to the access. The database management system 33 accesses the data store 27 in accordance with the commands of the control data received via the layout 35, and retrieves filtered data from the target data stored in the data store in response to the commands of the control data and provides the filtered data to the interface generator 31 for outputting to the user in a suitable format. Thus the user interface allows the user to conveniently access the big or other data in the data store 27 and output filtered data in a conveniently readable form to the user.

In terms of the application of the user interface system 11 to the target data described in the applicant's co-pending International Patent Application PCT/AU2015/050366, the user interface system 11 is used by a user 21 on a client 19 to access the server 17 and set filters to undertake particular analytics, diagnostics or reporting and provide output based on the target data in the data store 27 after it has been generated and stored in the data store as part of the overall data processing system. After the user sets the filters, the analytics and reporting engine provides for analysing and diagnosing the filtered data extracted from the target data. This enables the user to manage risks and issues at various levels within the particular group of target data.

The analytics and reporting engine 25 is also designed to generate output in the form of customised analysis, diagnostics and reports, depending upon the control data input by the user, using a prescribed report (not shown) generated by the interface generator 31 from the filtered data and provide this through the communications module 23 to the client 19 for display to the user 21.

Examples of the analytics and diagnostics that can be performed include forecasting, budgeting, ratio analysis, diagnostic flow charts, risk management, business valuations and Z-Scores. Examples of the reporting that can be performed include customised management reporting including historical information, board reporting, compliance reporting and statutory reporting, in full or part.

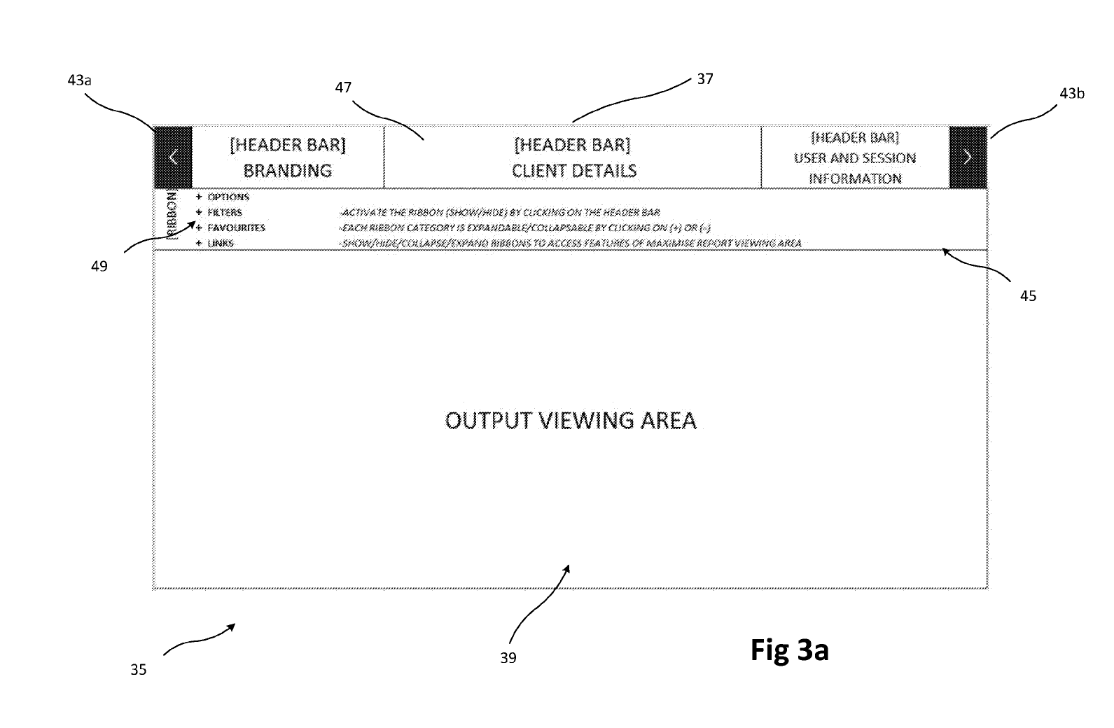

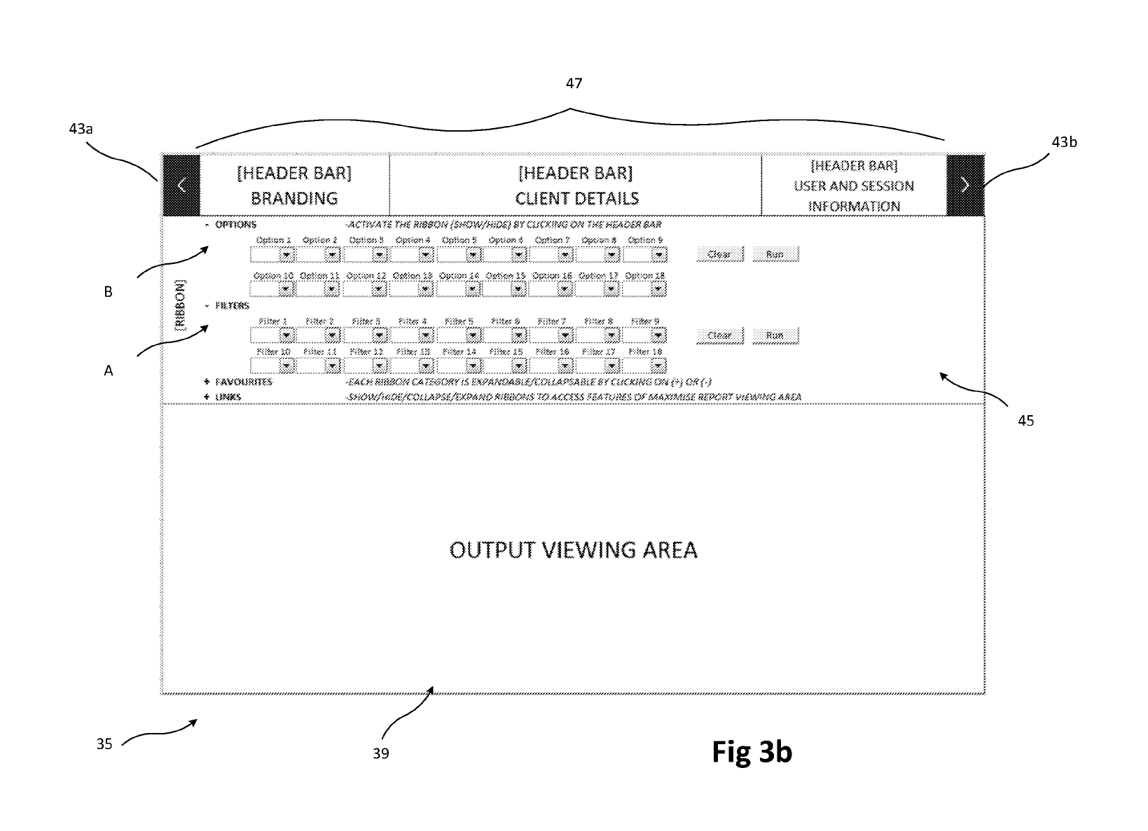

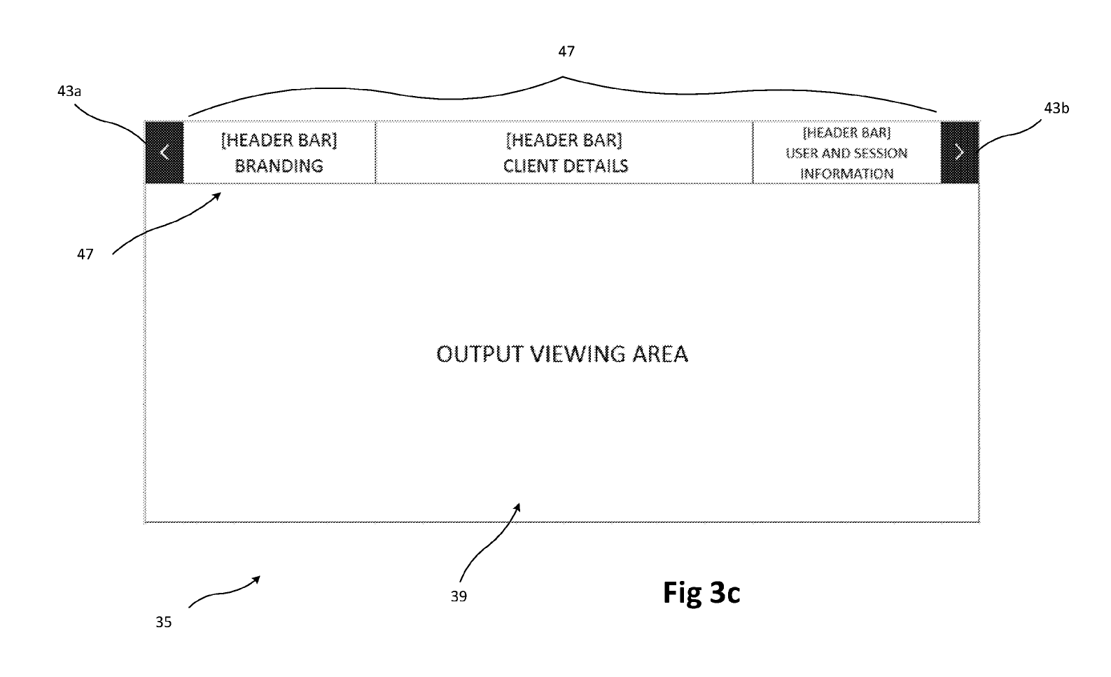

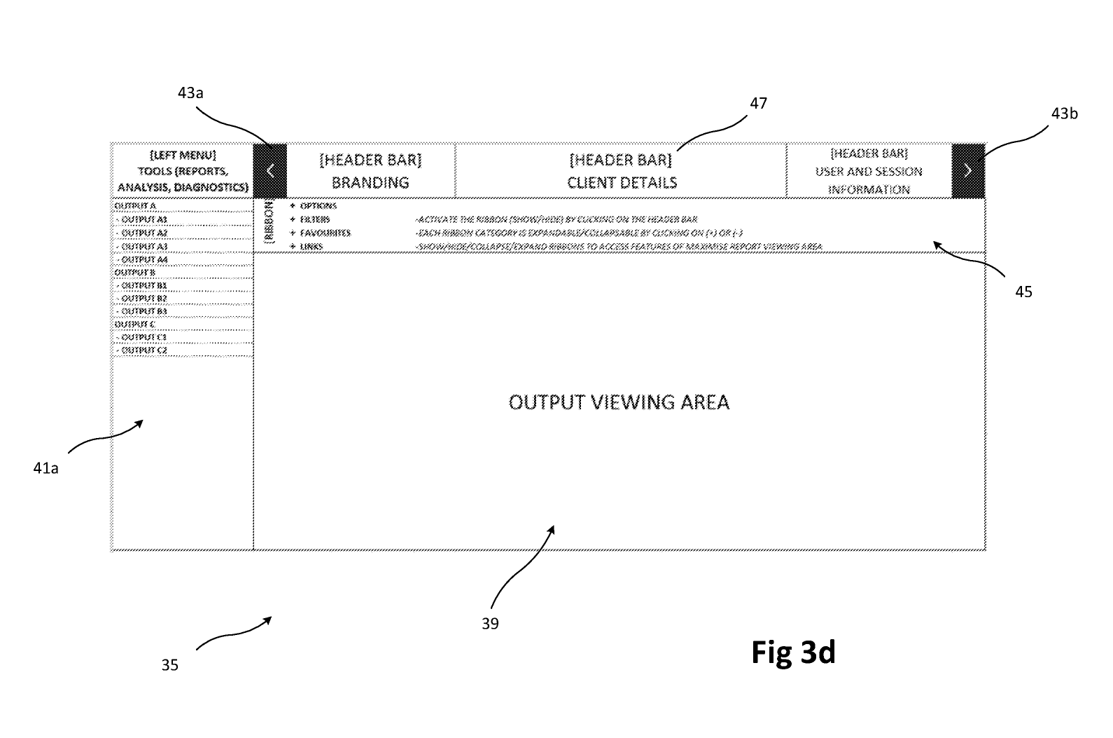

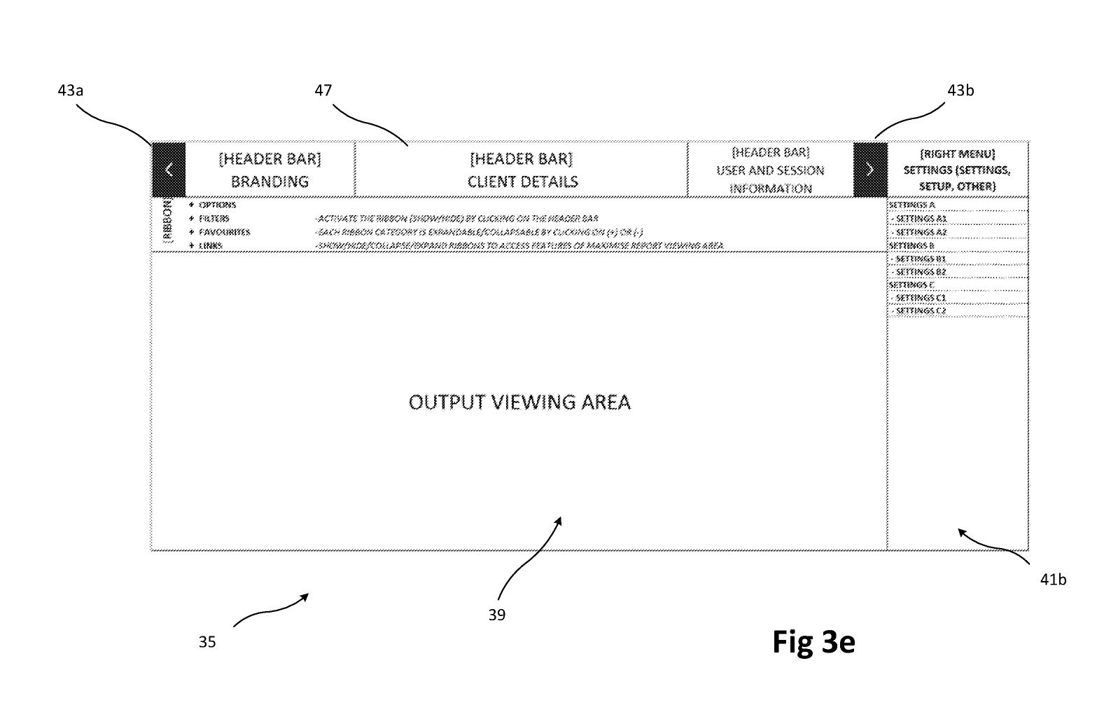

Now describing the user interface in more detail, reference is made to FIGS. 3a to 3e, where the layout 35 is shown comprising a bar in the form of a main header bar 37 divided into a plurality of expandable portions for inputting control data, and a main display pane 39 for outputting filtered data. The expandable portions are able to be selectively targeted by user input to provide extended areas that in the present embodiment are in the form of slide-out menus 41, having activatable portions 43a and 43b respectively disposed at opposing ends of the header bar 37, and an activatable ribbon 45, having an activatable portion 47 disposed intermediate the activatable portions 43. The main display pane is always maximised to provide the maximum area available on the layout for displaying the filtered data output from the database management system 33.

The expandable portions 43 and 47 of the main header bar can be selectively minimised or retracted so as not to encroach upon the main display pane 39. Alternatively, these expandable portions can be targeted to reveal a slide-out menu 45 in the case of the expandable portions 43a and 43b, or ribbon 45 in the case of the expandable portion 47 of the main header bar 37.

These slide-out menus 41 or ribbon 45 are designed to either encroach marginally into a portion of the main display pane 39, without obscuring the entire main display pane, or expand in a manner so as not to encroach upon the main display pane.

In the present embodiment, the activated ribbon 45 when minimised encroaches marginally into the top portion of the main display pane 39 as shown in FIG. 3a. As shown in FIG. 3b, the ribbon 45 can selectively be partially expanded or maximised fully (not shown) to encroach further into the top portion of the main display pane 39, but still not obscure the entire main display pane.

By way of contrast, the slide-out menus 41 are activated alternately by a user asserting either the expandable portion 43a to drop down the left-hand side menu as shown in FIG. 3d, or the expandable portion 43b to drop down the right-hand side menu as shown in FIG. 3e. In either case, when the expandable portion 43 is asserted, the particular slide-out menu 41 associated with it is displayed laterally of the main header bar 47, and the main display pane 39 is shifted in conjunction with the remaining portion of the main header bar in the opposite direction, so that the slide-out menu 41 does not encroach upon the main display pane. Thus in the case of the left-hand side slide-out menu, the slide-out menu 41a is displayed laterally to the left button 43a of the main header bar 47 so as not to encroach upon the main display pane 39, and simultaneously the main header bar 47 and the main display pane 39 are shifted to the right. In the case of the right hand side slide-out menu 41b, the opposite occurs.

The slide-out menus 41 include a series of menu selections and sub menu selections providing for different types of control settings for the user to choose or select from for accessing the big or other data in the data store.

In the case of the left-hand side slide-out menu 41a, control settings are arranged so that the user can choose or select different types of output that in the present embodiment may be analytic, diagnostic or report actions controlling the extraction and display of the filtered data as filtered from the target data. As shown in FIG. 3d, main menu headings are identified as Output A, Output B and Output C and each have submenus respectively identified as: Output A1, Output A2, Output A3 and Output A4: Output B1, Output B2 and Output B3: and Output C1 and Output C2.

In the case of the right hand side slide-out menu 41b, control settings are arranged governing the status and access of the user to the target data. As shown in FIG. 3e, main heading settings are identified as Settings A, Settings B and Settings, and each have submenus respectively identified as: Settings A2 and Settings A2; Settings B1 and Settings B2; and Settings C1 and Settings C2.

Although in the present embodiment slide-out menus 41 are provided at both ends of the main header bar 47, other embodiments provide for the provision of some or all of the control data in one slide-out menu only disposed at one end of the other end of the main header bar.

The activatable ribbon 45 is divided into discrete portions A, B, C, D for inputting different types of information. These discrete portions have their titles identified alongside radio buttons 49 when the ribbon is in the minimised state, as shown in FIGS. 3a, 3d and 3e. In the present embodiment, the titles are ‘OPTIONS’, ‘FILTERS’, ‘FAVOURITES’ and ‘LINKS’. By the user selecting a particular radio button, the ribbon 45 is expanded selectively to reveal the discrete portion A, B, C and/or D associated with the selected button and provide fields, links, menu selections and/or information for the user to input control data and initiate processing with such by the database management system 33.

As shown in FIG. 3b, the radio buttons for ‘FILTERS’ and ‘OPTIONS’ have been selected and the discrete portions A and B, respectively, have been expanded to reveal the relevant data entry fields are each. In this manner the activatable ribbon can be progressively maximised to the extent necessary, without encroaching upon the entire main display area 39.

In the present embodiment, the portion A allows the user to input configuration information as part of the control data to allow the user to filter the target data store and extract from it the filtered data for outputting to the user according to a prescribed range of filter settings available to the user. These settings include categories of data subsets relevant to the particular application.

The portion B allows the user to input formatting data as another part of the control data to allow the user to choose one of the plurality of format settings for displaying the filtered data according to a format setting of their choosing.

Particular users will require some or all of these filters and options, whereby those filters and options that are not applicable for a particular user are not displayed, thus restricting users to seeing what they are authorised to see.

Once the options and filters are set, the system is available for use by an authorised user to perform analysis, diagnostics and/or reporting according to the control settings chosen or selected for the particular output action specified by the user from the left-hand side slide-out menu 41a and in accordance with the control settings selected from the right hand side slide-out menu 41b governing the status and access of the user to the target data.

The portion C (not shown) provides for the user to select from a series of hyperlinks arranged in a menu configuration that are related to a set of prescribed analytics, diagnostics and reports that can be generated from the same configuration information entered by the user at A. Moreover, once the filters and options are set in portions A and B, and a filtered set of filtered data is extracted by the database management system 33 from the target data in the data store 27, there may be a number of different analytics, diagnostics or reports that can be generated from the same filtered data. For example, with financial data, once a filtered set of data is obtained for reporting purposes, various financial reports such as profit and loss, balance sheet, group level reporting etc. can be run from the same set of filtered data. The hyperlink facility avoids the need to select filters and options each time a prescribed output is run, providing a considerable saving in time and efficiency of the user.

The portion D (not shown) allows the user to create a ‘FAVOURITES’ list of previously stored configuration information from A and formatting data from B that the user may wish to use at a later time. This feature facilitates the user populating the respective fields in portions A or B by selecting from the ‘FAVOURITES’ list and running a prescribed report such as an analytic, diagnostic or report from within portion C using the previously stored configuration information and formatting data from the selected favourite.

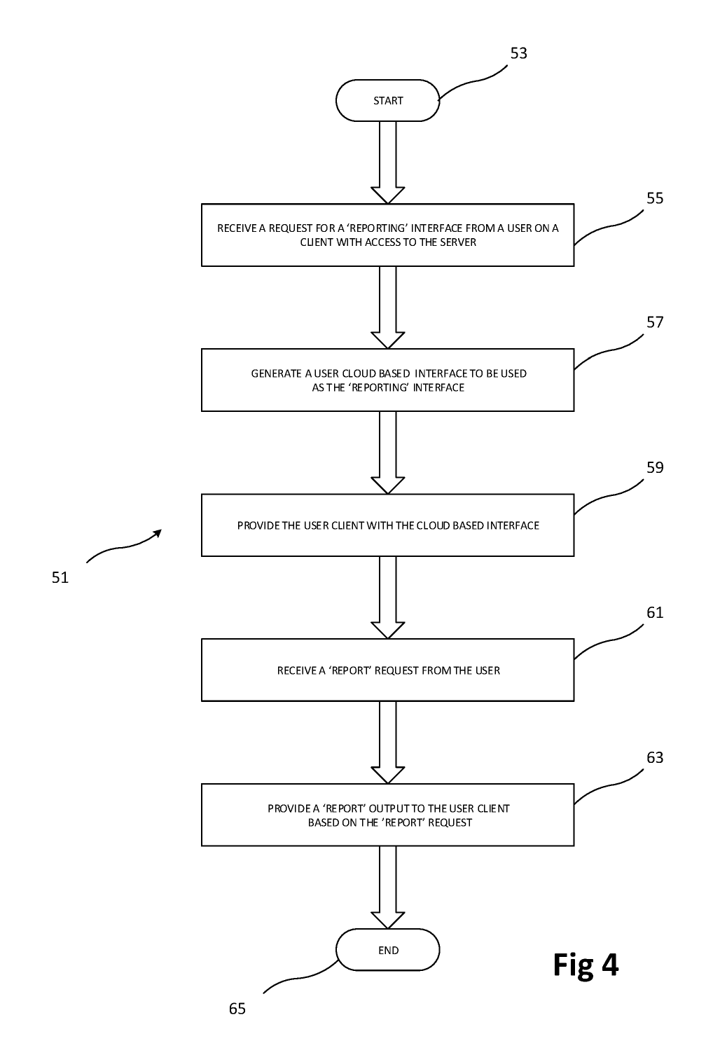

The general methodology followed by the user interface system 11 is shown in FIG. 4. The process 51 starts at step 53 where the server 17 waits to receive a request for invoking a ‘reporting’ interface layout from a user 21 on a client 19 with access to the server 17 at step 55. In the present embodiment, the server 17 receives the request via the communication module 23 and generates a user ‘cloud based’ interface to be used as the ‘reporting’ interface in the form of the layout 35 via the layout generator 31 of the analytics and reporting engine 25 at step 57. The server 17 then provides the user client 19 with the ‘cloud based’ interface layout 35 via the communication module 23 at step 59 and then waits to receive a ‘report’ request from the user 21 at step 61. After processing by the database management system 33 of the analytics and reporting engine 25, the server 17 provides a ‘report’ output to the user client 19 based upon the ‘report’ request at step 63. The process 51 then ends at step 65.

Once the appropriate ‘report’ selections are made by the user 21, which determine the particular type of output functions to be undertaken, the analytics and diagnosis engine 25 presents the selections in the form of a first query to the database management system 33 applying the selected filters and options to the financial data values of the target data stored in the data store 27, and then in the form of a second query applying the selected driver filters addressing the non-financial data values of the target data stored in the data store 27.

The results are then provided as filtered data in a ‘report’ output by a process applying the selected formatting options to the extracted data values and then, which is then compiled in a file for display output to the user 21 from the client 19.

In this manner, the user is able to ‘slice and dice’ target data information within the data store 27 to the extent that the user is authorised to do so by virtue of the options and filters settings that they are restricted to accessing this, and analytic, diagnostic and reporting formats which have been customised for the particular user and become the user's standardised format. Prior art analytics, diagnostics and reporting systems generally require technical skill by the end user to know commands and require the user to have intimate knowledge of the system to access information.

To achieve this, the input generator generally comprises:

(1) a user interface layout process for displaying: (i) the header bar divided into a plurality of expandable portions; (ii) the main display pane for displaying the output data to the user; and (iii) the extended area, extendable from each expandable portion; and

(2) a menu activation process responsive to user input targeted at one of the expandable portions to extend the extended area for the user to input specific control data.

The user interface layout process is configured to always maximised the main display pane so as to provide the maximum area available for displaying the filtered data by the menu activation process alternately:

(a) revealing the extended area in a manner so as to not, or minimally, encroach into the main display pane, mitigating the obscuration of the main display pane in response to a targeted user input; or

(b) minimising or retracting the extended area so as to not encroach upon the main display pane in response to another targeted user input.

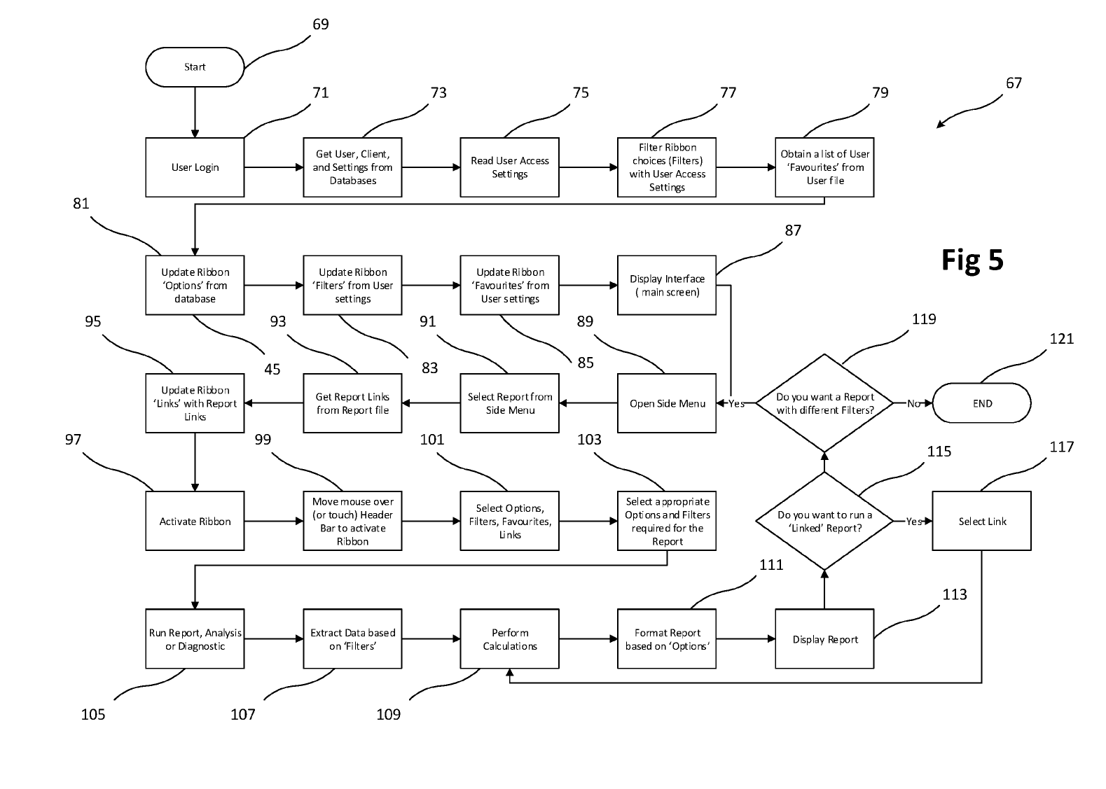

The process steps followed at a lower system level and performed by the server 17 are shown in FIG. 5. The process 67 starts at step 69 and proceeds with the user invoking a User Login process at step 71. A Get User, Client and Settings process is then initiated at step 73 where a Read User Access Settings process is then invoked at step 75. The Filter Ribbon choices process is then initialised with the User Access Settings at step 77. A list of User ‘Favourites’ is obtained from the User file storing the User Access Settings at step 79. The Ribbon ‘Options’ are then updated from the database storing the User Access Settings at step 81, the Ribbon ‘Filters’ are updated from the User Access Settings at step 83 and the Ribbon ‘Favourites’ are updated from the User Access Settings database at step 85 to finally display the interface layout on the main screen of the client 19 at step 87.

The process 67 then enters a loop where a series of processes are invoked, depending on the user activity including: Open Side Menu at step 89, Select Report from the Side Menu at step 91, Get Report Links from Report file at step 93, Update Ribbon ‘Links’ with Report Links at step 95 and Activate Ribbon at step 97. Activate Ribbon entails a process for sensing movement of the mouse over (or touch for a touch screen) Header Bar to activate Ribbon at step 99. Processes are then invoked for selecting Options, Filters, Favourites and Links at step 101 and selecting appropriate Options and Filters required for the Report at step 103. Processes for running the Report, Analysis Diagnostic at step 105 and extracting data from the data store 27 based on ‘Filters’ settings at step 107 are then performed. Calculations for deriving filtered data are performed at step 109 and the Report is formatted based on ‘Options’ settings at step 111 before being displayed at step 113.

Following these steps, the user's query as to whether they want to run a ‘Linked’ Report at 115, and if so the selected link asserted by the user at step 117 is then processed at step 109 where calculations are performed and steps 111 and 113 are repeated. Alternatively if a ‘Linked’ Report is not to be run from the query at step 115 then the user 21 is further queried as to whether they want to run a Report using different filter settings at step 119. If so, then the cycle of processes commencing with step 89 progressing through to step 113 is repeated. If not, then the overall process is ended at step 121.

As can be seen, the user interface described in the specific embodiment has a particular technical effect, aside of aesthetic and general intellectual considerations that otherwise have appeal to a user of the system. Moreover, the particular feature of dividing the main header bar 37 into a plurality of expandable portions having activatable portions 43 disposed at opposite ends of the header bar to produce the left-hand slide-out menu 41a or right-hand slide-out menu 41b, and/or the header bar itself in the case of the expandable portion 47 in producing the activatable ribbon 45 and/or the activatable ribbon in producing a slide-out menu that has different portions of it that can be minimised or maximised; or function in a special way to maximise the unobscured display region of the viewing area 39. Thus, the output data displayed in the viewing area, arising from either a report, analytics or diagnostics activity instigated by the user, can still be conveniently viewed by the user and change dynamically in a continuous manner contiguous one or more of the slide-out menus 41, whilst the user enters different control commands or filters via the slide-out menus.

In the case of the application described in the present embodiment, this feature presents a significant advantage and improvement over prior art graphic user interfaces, providing the user with considerable flexibility and real-time interaction with the target data being accessed in an extremely efficient manner. Moreover, the user interface reduces the number of clicks or steps in getting output such as reporting and in performing analytics and diagnostics. It allows interchanging between output specifying settings without having to generate data through a protracted extraction process. The interface is designed to preempt the users needs and can give the user a choice of ‘favourites’ outputs or ‘links’ to other forms of outputs with a single click or touch of the screen.

An example of this is where a user may generate a business report with specified options and filters. The filters could apply to a particular entity or geographical area within the data.

When the user displays the business report, the ribbon allows the user to keep the existing data set selected by the filters and options and click on a ‘link’ to an alternative report which would use the same set of data extracted. With a single click a user can jump across several reports with ease and display a variety of information relevant to the filtered dataset with a single click or touch of the screen.

Alternatively, the user may prefer to continue to use the existing report, but change the rules behind the options and filters. If the user has stored preferences with ‘options and filters’ as favourites, the user can click on a ‘favourite’ to an alternative dataset and/or formatting rules which would use the same report as before. If the changes are only to ‘options’ then the existing dataset can still be used. With a single click a user can jump across several reports with ease and display the same report for difference combinations of datasets and/or formatting rules with a single click or touch of the screen.

A second specific embodiment of the invention is substantially the same as the preceeing embodiment, but includes a configurations setting that invokes a process for hiding the bar when the output is generated and displayed in the main display area.

A third embodiment of the invention is substantially the same as the two preceding embodiments, except that the location of the ribbon and side menus are reversed. In this embodiment, the ribbon is disposed in an extended area located produced from an expandable portion at one or the opposite end of the main header bar, or it both ends, and the menu is disposed in the extended area expanded from one or more of the intermediary expandable portions of the bar.

It should be appreciated that the scope of the present invention is not limited to the specific embodiment described as the best mode for carrying out the invention. Changes and modifications to the processes described that achieve the same outcome of the present invention are envisaged to form part of the invention and do not detract from it. For example, although the specific embodiment is directed towards a cloud based solution using a browser where the layout may be presented in a webpage format downloaded from a server, the invention is not limited to such an embodiment and may have equal utility in a different network arrangement using an App where the layout is sourced from the client. Further still, the invention may have similar utility in a stand-alone system not involving communications across a network wherein a layout page is generated from within a computer and presented to a user of the computer for the purposes of interrogating a database system forming part of the computer.

It should also be appreciated that the invention may have utility outside of accessing big or other data that is generated for the purposes of the subject invention of the applicant's co-pending International Patent Application PCT/AU2015/050366. For example it may have equal utility in accessing target data having an astronomical or medical source, where a convenient user interface is desired or required. Other applications include inventory systems, payroll systems, library database data, archive database data comprising historical records, customer relationship management (CRM) data, fund/investment management data, property management data, and land or property title data.

1. A user interface system for accessing target data including:
an interface generator for generating a user interface layout for the purposes of inputting control data from a user to access the target data and for outputting data from the target data in response to the inputting of the control data;
wherein:
the user interface layout has: (i) a bar divided into a plurality of expandable portions, at least one expandable portion in its expandable form providing an extended area for the user to input the control data; and (ii) a main display pane for displaying the data output from the target data;
the main display pane is always maximised to provide the maximum area available for displaying the data; and
the one expandable portion of the main header bar can be selectively targeted by user input to:
(a) minimise or retract the extended area so that it does not encroach upon the main display pane; or alternatively
(b) reveal the extended area in a manner so as to not, or minimally, encroach into the main display pane, mitigating the obscuration of the main display pane.

2. The user interface system as claimed in claim 1, wherein the extended area is a ribbon that can selectively be:
(i) retracted in a deactivated state so as not to encroach upon the main display pane; or
(ii) extended to encroach minimally into the main display pane so as to mitigate the obscuration of the main display pane.

3. The interface system as claimed in claim 2, wherein the ribbon is activatable when extended and can selectively be:
(i) de-activated to encroach minimally into the main display pane so as to mitigate the obscuration of the main display pane; or
(ii) activated to encroach marginally further into the main display pane but still mitigating the obscuration of the main display pane.

4. The interface system as claimed in claim 2, wherein the ribbon has (A) a portion for inputting configuration information as a part of the control data to allow the user to filter the target data and extract from it output data to form filtered data for outputting to the user according to a prescribed range of filter settings available to the user.

5. The interface system as claimed in claim 4, wherein the activatable ribbon also has (B) another portion for inputting formatting data as another part of the control data to allow the user to choose one of a plurality of format settings for displaying the filtered data according to a format setting of their choosing.

6. The interface system as claimed in claim 4, wherein the activatable ribbon further has (C) a further portion for providing hyperlinks to a related set of prescribed analytics, diagnostics or reports that may be generated from the same configuration information entered at (A).

7. The interface system as claimed in 6, wherein the activatable ribbon further still has (D) a still further portion for providing a favourites list of previously stored configuration information from (A) and formatting data from (B) to facilitate the user populating the respective fields in (A) or (B) by selecting from the favourites list and entering (C) to provide a prescribed output using the previously stored configuration information and formatting data.

8. The interface system as claimed in claim 1, wherein the one expandable portion is disposed intermediate of the bar, and when expanded, the extended area associated therewith with is displayed adjacent and in parallel to the bar so as to encroach minimally upon the main display pane.

9. The interface system as claimed in claim 1, wherein the one expandable portion is disposed at one end of the bar and when expanded, the extended area associated therewith is displayed laterally of the bar so as not to encroach upon the main display pane, and the main display pane is shifted in conjunction with the remaining portion of the bar in the opposite direction.

10. The interface system as claimed in claim 9, wherein the extended area is a slide-out menu and includes a series of menu selections and sub menu selections providing for different types of control settings for the user to choose or select from for accessing the target data.

11. The interface system as claimed in claim 10, wherein the slide-out menu provides control settings for: (i) the user to choose or select different types of output for controlling the extraction and display of the output data; or (ii) governing the status and access of the user to the target data; or (iii) both (i) and (ii).

12. The interface system as claimed in claim 4, wherein in the case of (iii), the slide-out menu for (i) is located at one of the ends of the bar, and the slide- out menu for (ii) is located at the opposite end of the bar.

13. A method for a user accessing target data including:
generating a user interface layout so that it has: (i) a bar divided into a plurality of expandable portions at least one expandable portion in its expandable form providing an extended area for the user to input control data; and (ii) a main display pane for displaying the data output from the target data, the main display pane always being maximised to provide the maximum area available for displaying the data output from the target data;
wherein the one expandable portion of the bar can be selectively targeted by user input to: (a) minimise or retract the extended area so that it does not encroach upon the main display pane, or alternatively (b) reveal the extended area in a manner so as to not, or minimally, encroach into the main display pane, mitigating the obscuration of the main display pane.

14. The method as claimed in claim 13, wherein the extended area is a ribbon and the method includes: (i) retracting the ribbon in a deactivated state so as not to encroach upon the main display pane; or (ii) extending the ribbon to encroach minimally into the main display pane so as to mitigate the obscuration of the main display pane.

15. The as claimed in claim 14, including selectively: (i) deactivating the ribbon to encroach minimally into the main display pane so as to mitigate the obscuration of the main display pane; or (ii) activating the ribbon to encroach marginally further into the main display pane but still mitigating the obscuration of the main display pane.

16. The as claimed in claim 14, including dividing the ribbon into: (A) a portion for inputting configuration information as part of the control data to allow the user to filter the big or other data in the data store and extract only that data which is required to form the filtered data for outputting to the user according to a prescribed range of filter settings available to the user.

17. The as claimed in claim 14, including dividing the ribbon into: (B) another portion for inputting formatting data as another part of the control data to allow the user to customise the formatting of the filtered data for their own purposes.

18. The as claimed in claim 14, including dividing the ribbon into: (C) a further portion for providing hyperlinks to a related set of prescribed analytics, diagnostics or reports that may be generated from the same configuration information entered at (A).

19. The as claimed in claim 18, including dividing the ribbon into: (D) a still further portion for providing a favourites list of previously stored configuration information from (A) and formatting data from (B) to facilitate the user populating the respective fields in (A) or (B) by selecting from the favourites list and entering (C) to run a prescribed analytic, diagnostic or report using the previously stored configuration information and formatting data.

20. The as claimed in claim 13, including disposing one of the expandable portions at the end of the bar and expanding the extended area associated therewith to display laterally of the bar so as not to encroach upon the main display pane, and shifting the main display pane in conjunction with the remaining portion of the bar in the opposite direction.

21. The as claimed in claim 13, wherein the extended area is a slide-out menu of the one of the expandable portions includes a series of menu selections and sub menu selections providing for different types of control settings for the user to choose or select from for accessing the target data.

22. The as claimed in claim 21, the slide-out menu provides control settings for: (i) the user to choose or select different types of output for controlling the extraction and display of the target data; or (ii) governing the status and access of the user to the target data; or (iii) both (i) and (ii).

23. The as claimed in claim 22, wherein in the case of (iii), the method includes locating the slide-out menu for (i) at one of the ends of the bar, and locating the slide-out menu for (ii) at the opposite end of the bar.

24. A user interface system for accessing target data including:
an interface generator for generating a user interface layout for the purposes of inputting control data from a user to access the target data and for outputting data from the target data in response to the inputting of the control data;
the interface generator including:
a user interface layout process for displaying:
(i) a bar divided into a plurality of expandable portions;
(ii) a main display pane for displaying the output data to the user; and
(iii) an extended area extendable from each expandable portion
a menu activation process responsive to user input targeted at one of the expandable portions to extend the extended area for the user to input specific control data;
wherein the user interface layout process is configured to always maximise the main display pane so as provide the maximum area available for displaying the filtered data by the menu activation process alternately:
(a) revealing the extended area in a manner so as to not, or minimally, encroach into the main display pane, mitigating the obscuration of the main display pane in response to a targeted user input; or
(b) minimising or retracting the extended area so as to not encroach upon the main display pane in response to another targeted user input.
